(19) United States
(12) Patent Application Publication
(10) Pub. No.: US 2009/0307300 A1
(43) Pub. Date: Dec. 10, 2009

(54) METHOD AND SYSTEM FOR EXECUTING AN APPLICATION ON A MOBILE DEVICE

(75) Inventors: Isaac David Guedalia, Bet Shemesh (IL); Jacob Guedalia, Newton, MA (US)

Correspondence Address: PEPPER HAMILTON LLP, ONE MELLON CENTER, 50TH FLOOR, 500 GRANT STREET, PITTSBURGH, PA, 15219, US

(73) Assignee: ISKOOT INC., Cambridge, MA (US)

(21) Appl. No.: 12/482,134

(22) Filed: Jun. 10, 2009

Related U.S. Application Data
(60) Provisional application No. 61/060,139, filed on Jun. 10, 2008.

(51) Int. Cl. G06F 15/16; G06F 17/30

(52) U.S. Cl. 709/202; 707/3; 707/E17.014

(57) ABSTRACT

A system for executing an application on a mobile device may include a mobile device and a server in communication with the mobile device. The mobile device may include one or more widgets, a widget framework configured to receive a query from at least one of the widgets, and an encapsulator application configured to encapsulate the query. The computer-readable storage medium may include one or more programming instructions for performing one or more of the following: receiving the encapsulated query from the encapsulator application, extracting the query from the encapsulated query, and transmitting an update associated with the one or more widgets to the mobile device.

### CROSS REFERENCE TO RELATED APPLICATIONS

This application claims priority to U.S. Provisional Application No. 61/060,139 filed Jun. 10, 2008, the entirety of which is incorporated by reference herein.

Not Applicable

### BACKGROUND

A mobile device use often accesses, utilizes and/or interfaces with mobile device applications from different sources. A mobile device uses can request large amounts of content be downloaded onto the user's mobile device. For example, small utilities or applications, such as widgets, applets and/or the like are often used by mobile device users. As such, limited resources of a mobile device are typically divided among multiple programs, requests, downloads, widgets and/or the like which are vying for use of mobile device resources such as radio, CPU, bandwidth, network connectivity and/or the like. Application execution and competing access by numerous different applications on a mobile device typically leads to inefficiencies and time delays for a mobile device user.

### SUMMARY

Before the present methods are described, it is to be understood that this invention is not limited to the particular systems, methodologies or protocols described, as these may vary.

In an embodiment, a system for executing an application on a mobile device may include a mobile device and a server in communication with the mobile device. The mobile device may include one or more widgets, a widget framework configured to receive a query from at least one of the widgets, and an encapsulator application configured to encapsulate the query. The computer-readable storage medium may include one or more programming instructions for performing one or more of the following: receiving the encapsulated query from the encapsulator application, extracting the query from the encapsulated query, and transmitting an update associated with the one or more widgets to the mobile device.

In an embodiment, a system for executing an application on a mobile device may include a mobile device and a server in communication with the mobile device. The mobile device may include a first widget and a second widget, a widget framework configured to receive a first query from the first widget and a second query from the second widget, and an encapsulator application. The server may be in communication with a computer-readable storage medium which may include one or more programming instructions for performing one or more of the following: transmitting a first update associated with the first widget to the mobile device, and transmitting a second update associated with the second widget to the mobile device.

### BRIEF DESCRIPTION OF THE DRAWINGS

Aspects, features, benefits and advantages of the present invention will be apparent with regard to the following description and accompanying drawings, of which:

FIG. 1 illustrates an exemplary system for executing an application on a mobile device according to an embodiment.

FIG. 2 illustrates an exemplary method of executing an application on a mobile device according to an embodiment.

FIG. 3 illustrates an exemplary method of transmitting information to an application on a mobile device according to an embodiment.

FIG. 4 illustrates an exemplary system for executing a widget according to an embodiment.

FIG. 5 illustrates an exemplary method of executing an application on a mobile device according to an embodiment.

FIG. 6 illustrates an exemplary method of executing multiple widgets concurrently on a mobile device according to an embodiment.

### DETAILED DESCRIPTION

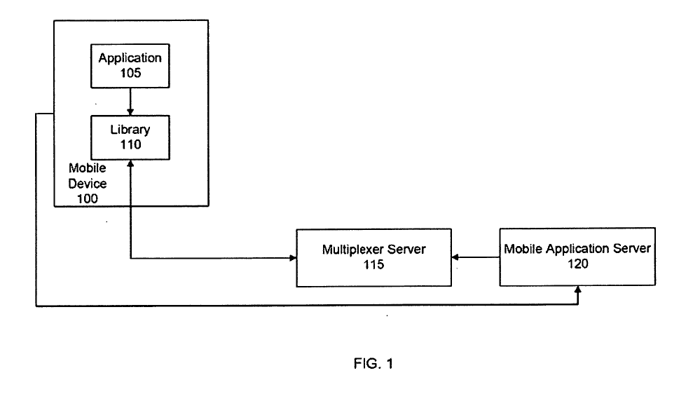

FIG. 1 illustrates an exemplary system for executing an application on a mobile device according to an embodiment. As illustrated by FIG. 1, a mobile device 100 may include one or more applications 105. An application 105 may be a software application, a hardware application, a combination of software and hardware applications and/or the like that is configured to operate and/or execute on a mobile device. In an embodiment, an application may be configured to perform a specific function for a user, other applications or programs and/or the like. For example, a mobile application may be a type of application. A mobile application may be an Internet application that may run on mobile devices. A mobile application may help a user connect to a network, such as the Internet, using a mobile device.

In an embodiment, an application may be downloaded to a mobile device from a source, such as a computing device, via a network. For example, an application may be downloaded to a mobile device via the Internet.

In an embodiment, a mobile device 100 may be a portable, electronic device that may have a processor and a processor-readable storage medium in communication with the processor. Exemplary mobile devices may include cellular phones, PDAs, media players and/or the like.

In an embodiment, a mobile device 100 may include a library 110. A library 110 may be a software application that operates on a mobile device 100 and that interacts with one or more applications. In an embodiment, a library 110 may store information associated with one or more applications on a mobile device. For example, a library 110 may store a name, application type, unique identifier, application capabilities and/or other information associated with an application. Exemplary application capabilities may be whether an application supports compressed data, whether the application supports Extensible Hypertext Markup Language (XHTML), whether the application requires protocols, such as SSL, HTTPS and/or the like.

In an embodiment, as illustrated by FIG. 1, a mobile device 100 may be in communication with a server 115. In an embodiment, the server 115 may be a computing device or other similar processing device. In an embodiment, the server 115 may be a multiplexer server. Although a multiplexer server is described, it is understood that any type of server or processing device may be used within the scope of this disclosure. The multiplexer server 115 may be associated with a first service provider. In an embodiment, a service provider may be an organization or entity that provides communications services, storage services, processing services and/or the like for mobile devices. For example, exemplary service providers may include wireless service providers, voice-over Internet protocol providers (“VoIP”), mobile solution providers, mobile-to-personal computer (“PC”) communication providers and/or the like. In an embodiment, a service provider may have a corresponding wireless network. A wireless network may enable communication between a plurality of mobile devices, computing devices and/or the like.

In an embodiment, the multiplexer server may be in communication with a computer-readable storage medium which may include one or more programming instructions. In an embodiment, the multiplexer server 115 may be in communication with a second server 120. The second server 120 may be a computing device or other similar processing device. In an embodiment, the second server may be associated with a second service provider. For example, the second server may be an application server, such as a mobile application server, associated with one or more of the applications on the mobile device. In an embodiment, the mobile application server 120 may provide updates to one or more applications. Although a mobile application server is described, it is understood that any type of server or processing device may be used within the scope of this disclosure.

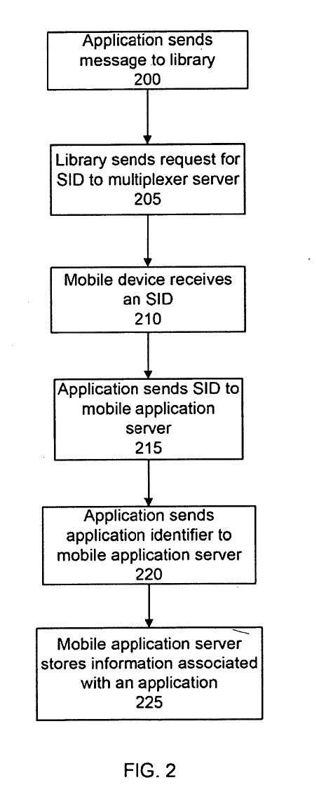

FIG. 2 illustrates an exemplary method of executing an application on a mobile device according to an embodiment. In an embodiment, an application may be executed on a mobile device by a user. For example, a user may select an application that the user wishes to run on a mobile device. A user may select an application by selecting an icon associated with the application or by otherwise instructing the mobile device to execute the application. In an alternate embodiment, an application may be automatically executed by a mobile device.

In an embodiment, when an application is executed on a mobile device, it may register with the library to gain access to mobile device resources, including, but not limited to, network connectivity. In an embodiment, registration may include the use of an application programming interface by the library. For example, a call-back methodology may be used by the application to register a callback function with the library.

The selected application 105 may send 200 a message or other request to the library 110. In an embodiment, the message may include information associated with the requesting application, the user, the mobile device 100 and/or the like. In response to receiving the message, the library 110 may send 205 a request to the multiplexer server 115 to obtain a session identification (SID). In an embodiment, the request may include information associated with the requesting application, the user, the mobile device 100 and/or the like.

In an embodiment, the mobile device 100 may receive 210 an SID. For example, a register on the multiplexer server 115 may generate and/or send a SID to the library of the mobile device. In an embodiment, the multiplexer server 115 may maintain a database of SIDs and associated mobile devices to which they correspond. In an embodiment, a SID may be valid for the duration of a single session. A session may be the time between the start and termination of an application's execution. Exemplary methods of performing authorization and/or authentication between a mobile device and the first server and/or between the first server and the second server are shown in, for example, U.S. Patent Application Publication No. 2008/0192910 to Guedalia.

In an embodiment, the application 105 may send 215 the received SID to the mobile application server 120. In an embodiment, an application identifier may be assigned to an application 105. For example, the first server may assign a unique application identifier to an application 105. The multiplexer server 115 may maintain a database of applications and associated application identifiers. In an embodiment, the multiplexer server 115 may transmit an associated application identifier to an application 105. The application 105 may send 220 its application identifier to the mobile application server 120. In an embodiment, the mobile application server 120 may store 225 information associated with one or more applications 105 including the corresponding SIDs and application identifiers.

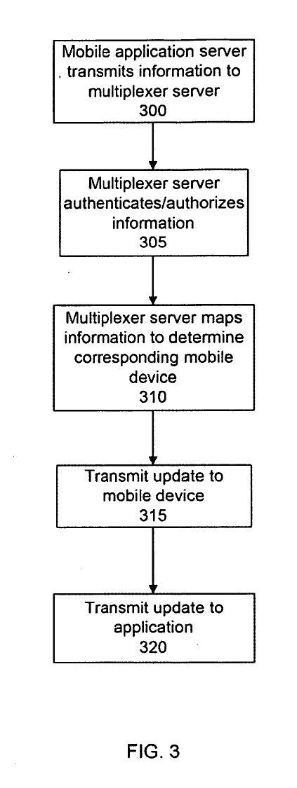

FIG. 3 illustrates an exemplary method of transmitting information to an application on a mobile device according to an embodiment. In an embodiment, the mobile application server 120 may use an SID and/or an application identifier to transmit 300 information, such as updates, notifications and/or the like to an application 105. In an embodiment, the mobile application server 120 may transmit 300 this information to the application 105 via the multiplexer server 1.15. Alternatively, the mobile application server 120 may transmit 300 this information directly to the application 105.

For example, the mobile application server 120 may transmit 300 an update to an application 105 on a mobile device 100. The mobile application server 120 may transmit 300 the update to the multiplexer server 115 along with the corresponding SID and/or application identifier associated with the application 105. The multiplexer server 115 may use the SID and/or application identifier to authenticate and/or authorize 305 the information. The multiplexer server 115 may then map 310 the SID and/or application identifier to determine a corresponding user and/or mobile device associated with the application 105. The update may then be transmitted 315 to the appropriate mobile device 100. For example, the update, SID and/or application ID may be transmitted 315 to the library 110 on the mobile device 100. The library 110 may notify the corresponding application 105 of the received update. For example, the library 110 may wakeup the corresponding application 100. The library 110 may transmit 320 the update to the application 105.

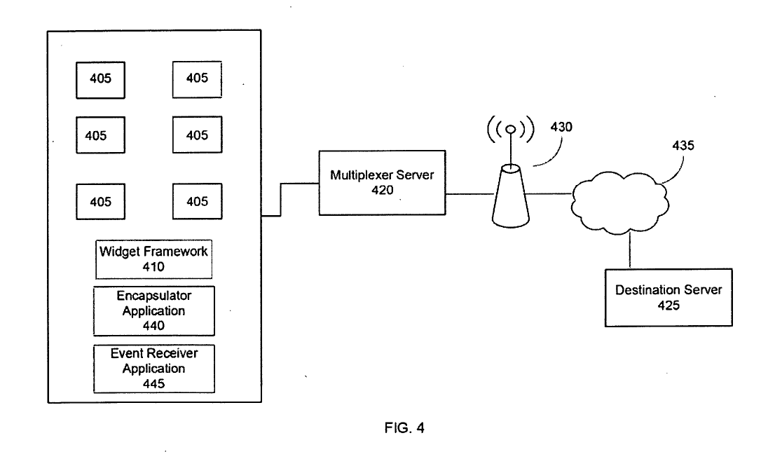

FIG. 4 illustrates an exemplary system for executing a widget according to an embodiment. In an embodiment, a widget may be a type of application. A widget may be a self-contained piece of code, programming instruction and/or the like. In an embodiment, a widget may include one or more instructions that instruct the computing device, mobile device and/or the like on which the widget is executing to perform a task.

In an embodiment, a widget 405 may be executed on a mobile device 400 and may be associated with one or more graphics that may be accessible on the mobile device. Such graphics may include buttons, boxes, icons and/or the like. For example, a home screen on a mobile device 400 may include one or more graphics associated with one or more widgets 405. A mobile device user may execute a widget 405 by selecting its corresponding graphic on the mobile device 400. For example, a user may select a widget 405 by highlighting, clicking or otherwise selecting a graphic. In an embodiment, a widget 405 may be executed on a mobile device 400 almost immediately after being selected. A widget 405 may be executed in a state that does not require transmission of data across a network.

In an embodiment, widgets 405 may be supported by a widget framework 410. A widget framework 410 may be a widget operating application that runs on a mobile device 400 when a widget 405 is executed. The widget framework 410 may load the widget 405 and may allocate one or more mobile device resources to the widget.

In an embodiment, a widget 405 may request a separate connection from the widget framework 410 to connect to a communication network 435, such as the Internet, an intranet, and/or the like via a carrier network 430. In an embodiment, a carrier network 430 may be an internal network supplied by a service provider which bridges and/or facilitates request from a mobile device 400 which is subscribed to the service provider. The carrier network 430 may allow a mobile device 400 to connect to the communication network 435. For example, a widget 405 may issue a query via the carrier network 430 and communication network 435 to access a destination server 425. A destination server 425 may process queries issued by a widget 405, and may return information to the multiplexer server 420. The multiplexer server 420 may propagate the destination server's response to the requesting widget.

Typically, as long as the widget framework is connected to the destination server via the carrier network, the carrier connection between the mobile device and the service provider may remain active. This can cause a drain on one or more resources of the mobile device such as radio, battery and/or the like. Network resources, such as a firewall, switches and/or the like may also be drained by a carrier connection between a mobile device and the service provider. This may be especially true for multiple widgets which may operate concurrently across a carrier network.

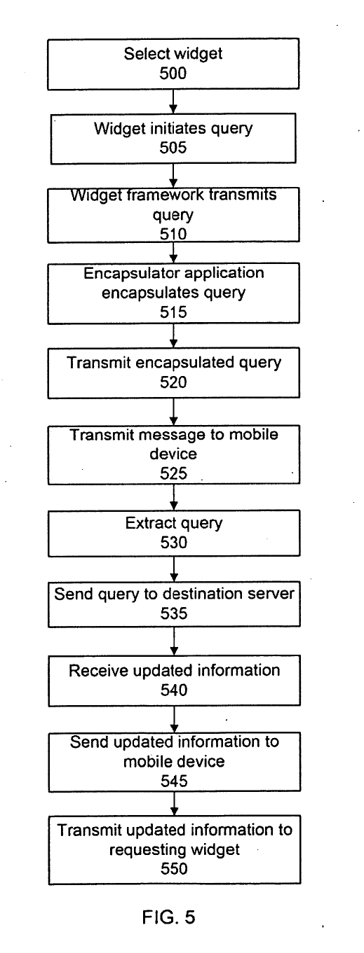

FIG. 5 illustrates an exemplary method of executing an application, such as a widget, on a mobile device, such as that illustrated by FIG. 4, according to an embodiment. A user may select 500 one or more widgets 405 to execute on a mobile device 400. The widget 405 may initiate 505 a query to the widget framework 410. For example, a widget 405 may invoke an API to initiate 505 a HTTP GET query to the widget framework 410. The widget framework 410 may transmit 510 the query to an encapsulator application 440. An encapsulator application 440 may be a software application, a hardware application and/or a combination of hardware and software applications. In an embodiment, an encapsulator application 440 may include one or more programming instructions that execute on the mobile device. In an embodiment, an encapsulator application 440 may be located on the mobile device 400.

The encapsulator application 440 may encapsulate 515 the query in an embodiment, encapsulation may include encoding the query. For example, the query may be URL encoded. In an embodiment, the query may be encoded within a JavaScript Object Notation (JSON)object. As such, the encapsulator application 440 may include one or more programming instructions for encapsulating a query. The encapsulator application 440 may transmit 520 the encapsulated query to the multiplexer server 420. The multiplexer server 420 may transmit 525 a message to the mobile device 400. For example, the multiplexer server 420 may transmit 525 a message to the widget framework 410. The message may include an acknowledgment of submission of the query. Upon receiving the message, the mobile device 400 may terminate its connection with, or disengage from, the multiplexer server 420.

In an embodiment, the encapsulator application 440 may queue widget requests based on one or more factors. For example, the encapsulator application 440 may queue widget requests based on which requests are more important to a user, when the requests are received, the availability of a selected destination server and/or other considerations.

In an embodiment, the multiplexer server 420 may receive an encapsulated query. The multiplexer server 420 may extract 530 the query. The multiplexer server 420 may run the query across the communication network 435 and carrier network 430. The multiplexer server 420 may send 535 the query to a destination server 425. In an embodiment, a destination server may be a computing device or other similar processing device associated with an address specified in a query. For example, a query may include a URL address. A destination server 425 may be a server associated with that URL address. In an embodiment, when the query is finished running, the multiplexer server may notify the widget framework. For example, the multiplexer server 420 may send the widget framework 410 an SMS message or other similar message.

In an embodiment, the multiplexer server 420 may receive 540 updated information from the destination server 425 in response to transmitting a query. The multiplexer server 420 may send 545 the updated information to an event receiver application 445 on the mobile device 400. The event receiver application 445 may be a software application, a hardware application, a combination of hardware and software applications and/or the like. In an embodiment, the event receiver application 445 may transmit 550 the updated information the widget 405 that requested it.

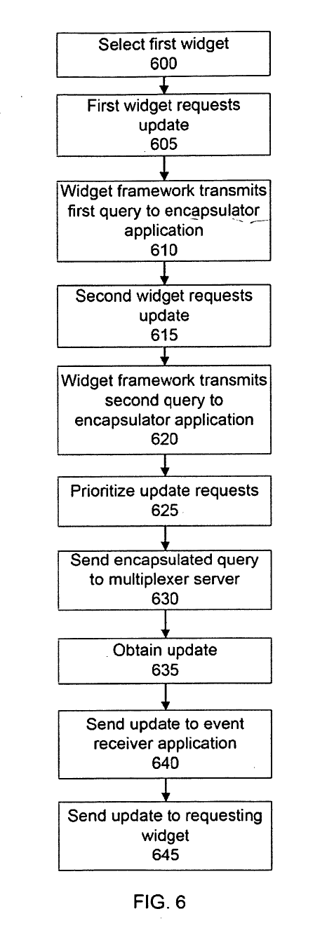

FIG. 6 illustrates an exemplary method of executing multiple widgets on a mobile device concurrently. In an embodiment, a user may select 600 a first widget application followed by a second application. For example, a user may select 600 a weather widget and a news widget. The weather widget may display an image, such as a picture of sun and clouds, on at least a portion of the mobile device's screen. The news widget may display a picture of a news station's logo.

In an embodiment, the first widget may request 605 an update from a specified destination server. For example, the weather widget may request 605 an update from a weather service. The widget may initiate a query for a destination server, for example, a server associated with a URL address such as http://weather.com. The widget framework may transmit 610 the first query to the encapsulator application. Similarly, the second widget may request 615 an update from a specified destination server. For example, the news widget may request 615 an update from a news service. The widget may initiate a query for a destination server, for example, a server associated with a URL address such as http://news.com. The widget framework may transmit 620 the query to the encapsulator application.

In an embodiment, the encapsulator application may prioritize 625 the widget update requests. For example, the encapsulator application may prioritize 625 the requests based on the order in which they were selected. In this case, the weather widget was selected prior to the news widget, so the encapsulator application may send the news update request first. In an embodiment, the encapsulator application may send 630 an encapsulated query to the multiplexer server. For example, the encapsulator application may send 630 an encapsulated “Get” request to the multiplexer server. The multiplexer server may access the specified destination server, and may obtain 635 an update. For example, the multiplexer server may access http://weather.com and obtain 635 a weather update.

The multiplexer server may send 640 this update to the event receiver application, which may send 645 the update to the widget requesting the update. The widget may execute, and the user may see a screen corresponding to the weather widget change to reflect the current weather forecast. When the multiplexer server transmits the request for a weather update to the http://weather.com website, the encapsulator application may send a request for a news update to the multiplexer server. The multiplexer server may access a news website, obtain a news update and transmit the update, via the event receiver application, to the news widget. The news widget may display this update on the user's mobile device.

In an embodiment, the multiplexer server may concurrently process multiple update requests. For example, one or more applications, widgets and/or the like may run in the foreground, while one or more applications, widgets and/or the like may run in the background. As such, a user may run multiple widgets without draining the resources of the mobile device because the multiplexer server handles the processing, and therefore absorbs the drain, associated with receiving updated information. It is understood that concurrent means substantially concurrent. As such, the multiplexer server may pause at times during the processing of multiple update requests or other information.

In an embodiment, a widget may be configured to continually monitor for updates. For example, a weather widget may be configured to constantly monitor for weather changes. The weather framework may issue an update request, such as an http “Get” command to access a specified URL, such as http://weather.com. The ecapsulator application may encapsulate the “Get” command, and may submit it to the multiplexer server for processing. The multiplexer server may connect to the specified URL and may constantly monitor for updates. When an update is detected, the multiplexer server may transmit the update to the event receiver application, which may transmit the update to the appropriate requesting widget. As such, a user may run widgets that continuously request updates without draining the resources of the mobile device because the multiplexer server handles the processing, and therefore absorbs the drain, associated with receiving updated information.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for executing an application on a mobile device, the system comprising:
a mobile device comprising:
one or more widgets,
a widget framework configured to receive a query from at least one of the widgets, and
an encapsulator application configured to encapsulate the query; and
a server in communication with the mobile device, wherein the server is in communication with a computer-readable storage medium comprising one or more programming instructions for performing one or more of the following:
receiving the encapsulated query from the encapsulator application,
extracting the query from the encapsulated query, and
transmitting an update associated with the one or more widgets to the mobile device.

2. The system of claim 1, wherein the widgets are configured to initiate an http query to the widget framework.

3. The system of claim 1, wherein the widget framework is configured to transmit the query to the encapsulator application.

4. The system of claim 1, wherein the encapsulator application is configured to transmit the query to the server via one or more of a communications network and a carrier network.

5. The system of claim 1, wherein the widget framework is configured to receive a message from the server, wherein the message comprises an acknowledgement of submission of the query to the server.

6. The system of claim 1, wherein the computer-readable storage medium comprises one or more programming instructions for transmitting the query to a destination server associated with a URL address specified by the query.

7. The system of claim 6, wherein the computer-readable storage medium comprises one or more programming instructions for performing one or more of the following:
receiving the update from the destination server;
transmitting the update to the widget framework.

8. The system of claim 7, wherein the widget framework is configured to perform one or more of the following:
receive the update from the server;
transmit the update to the widget that requested the update.

9. The system of claim 1, wherein the server is associated with a service provider.

10. A system for executing an application on a mobile device, the system comprising:
a mobile device comprising:
a first widget and a second widget,
a widget framework configured to receive a first query from the first widget and a second query from the second widget, and
an encapsulator application; and
a server in communication with the mobile device, wherein the server is in communication with a computer-readable storage medium comprising one or more programming instructions for performing one or more of the following:
transmitting a first update associated with the first widget to the mobile device, and
transmitting a second update associated with the second widget to the mobile device.

11. The system of claim 10, wherein the encapsulator application is configured to determine whether the first query should be processed before the second query based on one or more of the following:
an importance associated with the first query and the second query; and
which of the first widget and the second widget was selected first.

12. The system of claim 10, wherein the widget framework is configured to transmit the first query and the second query to the encapsulator application.

13. The system of claim 10, wherein the computer-readable storage medium comprises one or more programming instructions for performing one or more of the following:
transmitting the first query to a first destination server associated with a URL address specified by the first query;
receiving an update from the first destination server; and
transmitting the update to the widget framework.

14. The system of claim 13, wherein the widget framework is configured to transmit the update to the first widget.

15. The system of claim 10, wherein the computer-readable storage medium comprises one or more programming instructions for performing one or more of the following:
transmitting the second query to a second destination server associated with a URL address specified by the second query;
receiving an update from the second destination server; and
transmitting the update to the widget framework.

16. The system of claim 15, wherein the widget framework is configured to transmit the update to the second widget.

17. The system of claim 10, wherein the encapsulator application is configured to:
encapsulate the first query; and
transmit the encapsulated first query to the server via one or more of a communications network and a carrier network.

18. The system of claim 10, wherein the encapsulator application is configured to:
encapsulate the second query; and
transmit the encapsulated second query to the server via one or more of a communications network and a carrier network.
